(19) United States
(12) Patent Application Publication
(10) Pub. No.: US 2005/0039395 A1
(43) Pub. Date: Feb. 24, 2005

(54) Nursery tree pipe or conduit and a method of making the same

(76) Inventor: Michael Schwartz, Wilmington, DE (US)

Correspondence Address: POTTER ANDERSON & CORROON LLP;ATTN: KATHLEEN W. GEIGER, ESQ., P.O. BOX 951, WILMINGTON, DE, 19899-0951, US

(21) Appl. No.: 10/774,150

(22) Filed: Feb. 6, 2004

Related U.S. Application Data
(60) Provisional application No. 60/445,665, filed on Feb. 7, 2003.

(51) Int. Cl. A01G 17/14; A01G 17/04

(52) U.S. Cl. 47/47

(57) ABSTRACT

The present invention relates to an apparatus assembly for aiding in growing trees having straight trunks comprising a tubular metal pipe or conduit; a removable enclosing device engaged with the tubular metal pipe or conduit; an optional removable tapered stopper engaged with the tubular metal pipe or conduit, and optionally a means for connecting the tubular metal pipe or conduit to a tree. The present invention further relates to a method for making the tree pipe or conduit assembly.

This application claims the benefit of U.S. Provisional Application No. 60/445,665 filed on Feb. 7, 2003, which is incorporated by reference herein in its entirety.

### BACKGROUND OF THE INVENTION

1. Field of the Invention

The present invention relates to nurseries and the tree growing industry and an apparatus and method for ensuring that the trees or other types of plants grow having straight trunks.

2. Description of Related Art

In the tree growing or nursery industry, it is desired to produce the most visually appealing trees and plants that are also very healthy. Many devices have been created to produce these appealing and healthy trees and plants. These products include tree bracing or staking products such as, for example, plant protectors that shelter small seedlings, tree fertilizer and irrigation delivery systems for use with small plants, tree straightening devices for use with trees that have already become bent or crooked and need subsequent straightening, and tree bracing devices to prevent trees from falling over.

The staking of trees is a well-known practice within the art. Generally, staking is performed in order to encourage immature trees to grow in a substantially vertical fashion, thereby resulting in the tree having a straight trunk that does not have any bends or significant variations from the tree's vertical axis.

Staking of trees is important within the nursery industry because straight trunked trees have a significantly greater value in the marketplace than those trees that have bends, sways or other trunk irregularities. Typically, those irregular trees have a reduction in value of about 10-30% when compared to those trees having substantially straight trunks.

Various types of tree stakes have been described in the art. These and other types of devices are described in U.S. patents and periodical or internet articles, such as, for example U.S. Pat. No. 4,357,884; U.S. Pat. No. 4,745,706; U.S. Pat. No. 6,371,432; U.S. Pat. No. 6,299,125; U.S. Pat. No. 4,520,590; U.S. Pat. No. 4,268,992; U.S. Pat. No. 6,128,851; U.S. Pat. No. 4,897,956; U.S. Pat. No. 6,460,289; U.S. Pat. No. 5,129,179; U.S. Pat. No. 6,363,655; U.S. Pat. No. 6,073,391; U.S. Pat. No. 4,738,050; U.S. Pat. No. 4,881,342; U.S. Pat. No. 5,199,677; U.S. Pat. No. 5,568,700; U.S. Pat. No. 6,401,385; U.S. Pat. No. 4,750,293; U.S. Pat. No. 6,216,387; U.S. Pat. No. 4,176,494; U.S. Pat. No. 5,881,495; U.S. Pat. No. 6,065,243; U.S. Pat. No. 500,140; U.S. Pat. No. 3,010,256; U.S. Pat. No. 3,521,401; U.S. patent application Publication No. US 2002/0011023 A1, an internet article from Jersey Shore Steel Company at www.jssteel.com regarding rail steel orchard posts; an internet article at www.jimssupply.com for the “Superstake”; and an internet article from the Pennsylvania State University College of Agricultural Sciences regarding tree support systems at www.tfpg.cas.psu.edu/part1/part13g.html

However, in general, nurseries and tree growing facilities have employed the use of bamboo stakes or wooden stakes made from woods such as oak because they provide a level of stability for trees at a low initial cost. However, stakes of these types have several problems such as fraying, splitting and/or rotting due to exposure to the natural elements for any extended period of time and the like. This exposure necessitates that nurseries and other tree growing facilities replace the stakes, sometimes several times a year, in order to provide the tree with the required level of tree stability and growing guidance. Thus, there is a need within the industry to develop an apparatus which provides the requisite level of tree stability and guidance, flexibility to account for high winds and other environmental forces while being resilient enough to recover to a straight position, durability and cost effectiveness. The present invention addresses these needs within the industry. Furthermore, the present invention provides greater safety for users both during its use or when not in use during storage.

In addition, typical methods used within the art to insert the tree stakes into the ground includes the use of a heavy duty steel bar to form a pilot hole, into which the tree stake is inserted. Thus, the various embodiments of the present invention are advantageous because they can be inserted into the ground in a more efficient manner due to having both fewer steps and equipment requirements.

### SUMMARY OF THE INVENTION

The present invention relates to an apparatus assembly comprising:
(a) a tubular metal pipe or conduit having an upper end and a lower end;
(b) an enclosing device removably engaged with said upper end of the tubular metal pipe or conduit; and optionally
(c) a tapered stopper removably engaged with said lower end of the tubular metal pipe or conduit.

The present invention may further comprise:
(d) a means for connecting the tubular metal pipe or conduit to a tree, plant or the like.

The present invention also relates to a process for making the present invention. The process comprises the steps of:
(i) engaging an enclosing device with an upper end of a tubular metal pipe or conduit;
(ii) engaging a tapered stopper with a lower end of the tubular metal pipe or conduit.

### BRIEF DESCRIPTION OF THE DRAWINGS

FIG. 1 is an exploded view of an embodiment of the present invention.

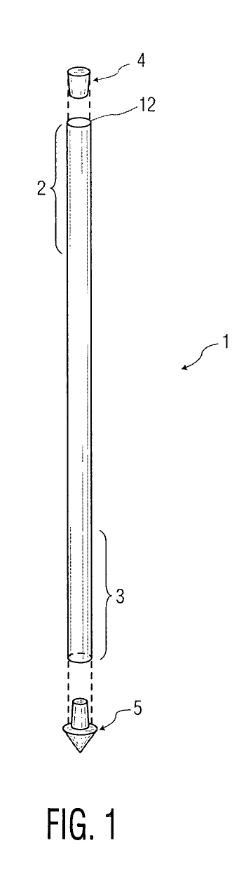

FIG. 2 is a side view of an embodiment of an enclosing device according to the present invention.

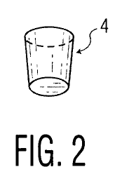

FIG. 3 is a side view of an embodiment of a tapered stopper according to the present invention.

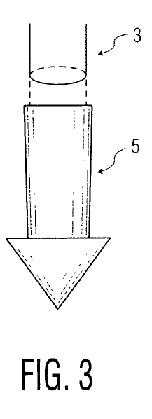

FIG. 4 is a side view of another embodiment of a tapered stopper according to the present invention.

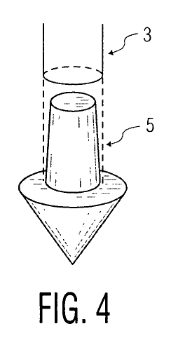

FIG. 5 is a side view of an embodiment of a tubular pipe or conduit according to the present invention having a flattened lower end.

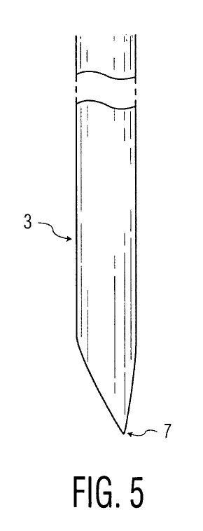

FIG. 6 is a side view of an embodiment of a tubular pipe or conduit according to the present invention having a flattened end and perforations or apertures.

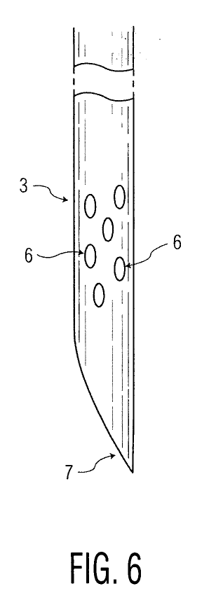

FIG. 7 is a frontal view of an embodiment of a tubular pipe or conduit according to the present invention having a flattened lower end and additionally cut at approximately a 45-degree angle.

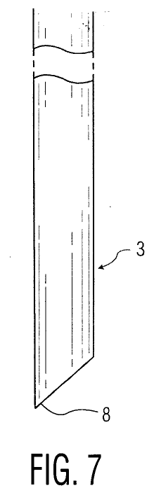

FIG. 8 is a side view of an enclosing device according to the present invention having an inlet or nipple.

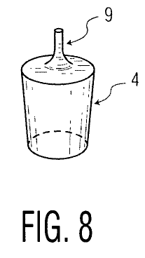

FIG. 9 is a view of a plurality of the present invention used in conjunction with a tree and an irrigation system.

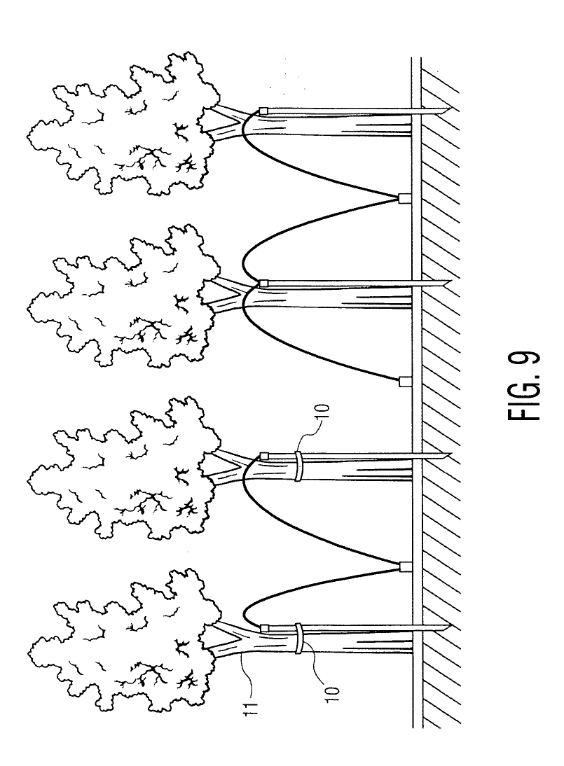

### DETAILED DESCRIPTION OF THE INVENTION

The present invention generally relates to an apparatus for trees, such that, it provides trees having substantially straight trunks without any significant bending. Thus, the present invention is used and intended to aid in the growth of a more valuable tree.

The present invention relates to an apparatus assembly comprising:
(a) a tubular metal pipe or conduit having an upper end and a lower end;
(b) an enclosing device removably engaged with said upper end of the tubular metal pipe or conduit; and optionally
(c) a tapered stopper removably engaged with said lower end of the tubular metal pipe or conduit.

The present invention may further comprise:
(d) a means for connecting the tubular metal pipe or conduit to a tree, plant or the like.

The present invention also relates to a process for making the present invention. The process comprises the steps of:
(i) engaging an enclosing device with an upper end of a tubular metal pipe or conduit;
(ii) engaging a tapered stopper with a lower end of the tubular metal pipe or conduit, and optionally
(iii) providing means for connecting the tubular metal pipe or conduit to a tree.

As used herein, the terms “engaging,” “engaged” or a derivative thereof shall mean joining, connecting, inserting, enveloping, the union of, the mating of, assembling, combining, or putting together of the various aspects or pieces of the present invention.

The components of the present invention may be adjusted proportionally to any size in order to accommodate not only trees, but other types of bushes, shrubs, plants and flowers. Preferably, however, the present invention is used in conjunction with immature trees.

In general, the tubular metal pipe or conduit (1) according to the present invention may comprise any type of metal that is resistant to rusting, for example stainless steel or galvanized steel, however, galvanized steel is preferred.

The pipe or conduit (1) may be of any length capable of providing the necessary guidance and support for the tree with which it is being used. However, the pipe or conduit (1) preferably has a fixed length ranging from about 6 feet to about 15 feet, wherein the tubular pipe or conduit does not allow for a telescoping action. The pipe or conduit (1) comprises an upper end (2) and a lower end (3) capable of receiving the enclosing device (4) and the tapered stopper (5). Since the diameter of the tubular pipe or conduit is consistent along the entire length of the pipe or conduit, the enclosing device and tapered stopper may be used interchangeably at either the upper or lower end of the pipe or conduit.

Preferably, the tubular pipe or conduit (1) is hollow to allow for a greater level of flexibility, a lighter weight for ease of use and cost effectiveness, and a method of delivering water, fertilizer or other nutrients to the root system of the tree.

The tubular pipe or conduit (1) may be of any diameter necessary to provide the pipe or conduit with an appropriate level of flexibility and resiliency, however the tubular pipe or conduit preferably has an outside diameter of about ½ inch to about 1 inch, most preferably it has an outside diameter of about 0.922 inches. The wall thickness of the pipe or conduit is typically described according to the gauge measurement of the tubular pipe or conduit, which is most preferably about 0.049 inches. Preferably, the tubular pipe or conduit has a gauge ranging from about 15 to about 19, and most preferably a gauge of 18, which provides the proper balance of durability, structural strength, affordability, and usable weight.

An alternative embodiment of the tubular pipe or conduit provides for a portion of the lower end (3) to be perforated or have apertures or holes (6), above the end accepting the tapered stopper, or alternatively, above a crimped or flattened portion (7) of the lower end (3). Thus, this embodiment would allow for the passage of water, fertilizers and/or other nutrients to pass from inside the tubular pipe and into the ground.

Another alternative embodiment of the tubular pipe or conduit (1) provides for a portion of the lower end (3) to be crimped or flattened (7) such that the tapered stopper is not required for insertion of the invention into the ground. In this instance, the flattened or crimped end of the tubular pipe or conduit may further be sharpened to a point or an edge (8) in order to aid in its insertion into the ground. The flattened or crimped lower end of the tubular pipe or conduit may further be cut at an angle, thereby further facilitating the invention's ease of use. In general, the angle may be of any degree, however, a 45-degree angle is preferred.

The enclosing device (4) for use in accordance with the present invention may be used with either end of the tubular pipe or conduit (1). It may envelope the end of the pipe or conduit, or alternatively, may be inserted into the end of the pipe or conduit. The enclosing device (4) prevents unintended water, dirt or other debris from entering into the tubular pipe or conduit thereby causing blockages and/or rusting or other degradation of the tubular pipe or conduit. The enclosing device (4) is removable, such that water, fertilizer or other nutrients may be delivered to the tree without contamination from the environment. The enclosing device may be made from hard or soft plastic, hard or soft rubber, metal and the like. Most preferably the enclosing device (4) has a cap configuration made from soft, pliable, weather resistant rubber or plastic.

Alternatively, the enclosing device (4), and thus either one or both ends of the tubular pipe or conduit (1), may be threaded so as to accept the enclosing device and aid in its retention and removal from the pipe or conduit, wherein the enclosing device is made from plastic, hard rubber or metal. Preferably, however, the enclosing device (4) may be slipped or disposed over either end of the tubular pipe or conduit, wherein the enclosing device (4) may be made from a soft, but weather resistant, pliable rubber or plastic.

Another alternative embodiment of the enclosing device (4) provides for an inlet or nipple (9) that allows for the attachment of a hose or other water delivery device to result in the flow of water into the present invention. The present invention may stand as a single pipe for water delivery or may be used in series where several pipes or conduits are fluidly connected either to one another or each is fluidly connected to a single water source. Thus, the present invention is able to deliver water below the surface of the ground and into the direct vicinity of the root rather than having any significant amount of water being lost to evaporation, run-off or other type is dissipation.

The enclosing device (4) may also act to ensure the safety of a user. The exposed edge (8) of the tubular pipe or conduit (1) may be rough and capable of inflicted injury to a user. However, the enclosing device (4), when it envelops the upper end of the tubular pipe or conduit, acts to cover any roughness and thereby protects the user.

The removable tapered stopper (5) in accordance with the present invention is typically used in order to prevent unintended dirt, water or other contaminants from entering the inside of the tubular pipe or conduit thereby preventing rusting or other degradation of the tubular pipe or, conduit (1) and aids in the insertion of the tubular pipe or conduit into the ground because the stopper (5) is tapered until it results in a substantially pointed tip. The tapered stopper (5) may be inserted into either end of the pipe or conduit, or alternatively, the stopper (5) may be fitted onto the pipe or conduit such that the stopper (5) fits over the end of the pipe or conduit.

The tapered stopper (5) may be solid or at least partially hollow with apertures in order to allow for delivery of water, fertilizers and/or other nutrients to the tree's root system. Thus, the stopper (5) may be made of any material capable of withstanding the forces exerted upon it due to its insertion into the ground and is resistant to rusting or other degradation wherein the material may be those such as, for example, stainless steel, galvanized steel, hard plastic, hard rubber and the like. Preferably, the stopper is a hard plastic material.

The removable tapered stopper (5) also offers a level of safety to any user, in that, when the tubular pipe or conduit is not in use, the tapered stopper may be removed, thereby lessening the likelihood of injury. Utilizing a permanently fixed point would be inherently more dangerous than the present invention.

In addition the removability of the tapered stopper (5) allows for greater versatility, in that, if a particular stopper breaks, becomes dull and therefore less effective, or is otherwise damaged the tapered stopper may be replaced with a new one without having to replace the entire device of the present invention.

Typically the tapered stopper (5) has a diameter that is slightly less than or slightly greater than that of the tubular pipe or conduit in order to ensure it remains in the proper position during its use. The length of the tapered stopper (5) may generally from about 1% to about 2% of the overall length of the invention, however it is preferably about 1-3 inches regardless of the overall length of the present invention.

In general, a means of connection (10) is used to secure the tubular metal pipe or conduit to the tree (11), plant and the like. This means of connection (10) is utilized in order to allow the present invention to aid in the growing tree having a straight trunk. The means for connection (10) may be any conventional means known within the art including, but not limited to elastic ribbon, a rubber tie, a plastic zip-tie, a Velcro® strip, string or rope or other like method for securing the tree pipe or conduit to the tree trunk.

The means for connecting the present invention with a tree may be used singly or in plurality, so long as the flexibility and resiliency of the invention is not compromised.

1. An apparatus assembly comprising:
(a) a tubular metal pipe or conduit having an upper end and a lower end;
(b) an enclosing device removably engaged with said upper end of the tubular pipe or conduit; and,
(c) a tapered stopper removably engaged with said lower end of the tubular metal pipe or conduit.

2. The apparatus according to claim 1 further comprising
(d) a means for connecting the tubular metal pipe or conduit to a tree.

3. The apparatus according to claim 1, wherein the tubular metal pipe or conduit has a diameter ranging from about ½ inch to about 1 inch.

4. The apparatus according to claim 3, wherein the tubular metal pipe or conduit has a diameter of about 0.922 inches.

5. The apparatus according to claim 1, wherein the tubular metal pipe or conduit has a length ranging from about 6 to about 15 feet.

6. The apparatus according to claim 1, wherein the tubular metal pipe or conduit has a gauge ranging from 15-19.

7. The apparatus according to claim 6, wherein the tubular metal pipe or conduit has a gauge of 18.

8. The apparatus according to claim 2, wherein the means for connection is an elastic ribbon.

9. The apparatus according to claim 1, wherein the tubular pipe or conduit has apertures.

10. A process for making the apparatus of claim 1 comprising:
(j) engaging an enclosing device with an upper end of a tubular metal pipe or conduit;
(ii) engaging a tapered stopper with a lower end of the tubular metal pipe or conduit; and, optionally
(iii) providing a means for connecting the tubular metal pipe or conduit to a tree.

11. An apparatus assembly comprising:
(a) a tubular metal pipe or conduit having an upper end and a flattened lower end, and
(b) a cap removably engaged with said upper end of the tubular pipe or conduit.

12. The apparatus assembly according to claim 11 further comprising
(c) a means for connecting the tubular metal pipe or conduit to an immature tree.

13. The apparatus according to claim 11, wherein the tubular metal pipe or conduit has a diameter ranging from about ½ inch to about 1 inch.

14. The apparatus according to claim 13, wherein the tubular metal pipe or conduit has a diameter of about 0.922 inches.

15. The apparatus according to claim 11, wherein the tubular metal pipe or conduit has a length ranging from about 6 to about 15 feet.

16. The apparatus according to claim 11, wherein the tubular metal pipe or conduit has a gauge ranging from 15-19.

17. The apparatus according to claim 16, wherein the tubular metal pipe or conduit has a gauge of 18.

18. The apparatus according to claim 1, wherein the tapered stopper is solid.

19. The apparatus according to claim 12, wherein the means for connection is an elastic ribbon.

20. The apparatus according to claim 11, wherein the tubular pipe or conduit has apertures.
